(19) United States
(12) Patent Application Publication
(10) Pub. No.: US 2017/0046910 A1
(43) Pub. Date: Feb. 16, 2017

(54) GAMING SYSTEM WITH SYMBOL CLUMP FEATURE

(71) Applicant: BALLY GAMING, INC., Las Vegas, NV (US)

(72) Inventors: NATHAN D. SHERRETS, CEDAR RAPIDS, IA (US); AARON J. SCHURMAN, CEDAR FALLS, IA (US); BRYAN J. VANDAELE, CEDAR FALLS, IA (US)

(21) Appl. No.: 14/823,841

(22) Filed: Aug. 11, 2015

(51) Int. Cl. G07F 17/32; G07F 17/34

(52) U.S. Cl. CPC G07F 17/3213; G07F 17/34; G07F 17/3246; G07F 17/3255; G07F 17/3251; G07F 17/3227

(57) ABSTRACT

A gaming system comprising a regulated gaming machine primarily dedicated to playing at least one casino wagering game. The gaming machine includes an electronic display device and a value input device and game-logic circuitry configured to display, on the electronic display device, a plurality of symbol-bearing reels, each reel having a plurality of reel positions occupied by symbols. The symbols on at least one of the reels includes a symbol clump occupying two or more adjacent reel positions of the plurality of reel positions of the at least one of the reels. The game-logic circuitry is further configured to detect, via the value input device, a physical item associated with a monetary value that establishes a credit balance, receive an input indicative of a wager covered by the credit balance, spin and stop the plurality of reels to land a subset of the symbols on the reels in visual association with an array of positions. In response to the symbol clump landing at least partially in the array, the game-logic circuitry is further configured to modify an attribute of the array in accordance with an extent to which the symbol clump lands in the array.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming systems, machines, and methods and, more particularly, to a gaming system, machine, and method with a symbol clump feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

### SUMMARY OF THE INVENTION

According to one aspect of the present invention, a gaming system comprises a regulated gaming machine primarily dedicated to playing at least one casino wagering game. The gaming machine includes an electronic display device and a value input device, and game-logic circuitry. The game-logic circuitry is configured to display, on the electronic display device, a plurality of symbol-bearing reels, each reel having a plurality of reel positions occupied by symbols. The symbols on at least one of the reels includes a symbol clump occupying two or more adjacent reel positions of the plurality of reel positions of the at least one of the reels. The game-logic circuitry is further configured to detect, via the value input device, a physical item associated with a monetary value that establishes a credit balance, receive an input indicative of a wager covered by the credit balance, and spin and stop the plurality of reels to land a subset of the symbols on the reels in visual association with an array of positions. In response to the symbol clump landing at least partially in the array, the game-logic circuitry is further configured to modify an attribute of the array in accordance with an extent to which the symbol clump lands in the array. The gaming system may be incorporated into a single, freestanding gaming machine.

According to another aspect of the invention, a casino gaming machine primarily dedicated to playing at least one casino wagering game, comprises an electronic display device, a value input device, and game-logic circuitry. The game-logic circuitry is configured to display, on the electronic display device, a plurality of symbol-bearing reels, each reel having a plurality of reel positions occupied by symbols. The symbols on at least one of the reels includes a symbol clump occupying two or more adjacent reel positions of the plurality of reel positions of the at least one of the reels. The game-logic circuitry is further configured to detect, via the value input device, a physical item associated with a monetary value that establishes a credit balance, receive an input indicative of a wager covered by the credit balance, and spin and stop the plurality of reels to land a subset of the symbols on the reels in visual association with an array of positions. In response to the symbol clump landing at least partially in the array, the game-logic circuitry is further configured to modify an attribute of the array in accordance with an extent to which the symbol clump lands in the array.

According to another aspect of the invention, a method of operating a gaming system primarily dedicated to playing at least one regulated casino wagering game, the gaming system including game-logic circuitry and a gaming machine, the gaming machine including an electronic display device and a value input device, comprises displaying, on the electronic display device, a plurality of symbol-bearing reels, each reel having a plurality of reel positions occupied by symbols. The symbols on at least one of the reels including a symbol clump occupying two or more adjacent reel positions of the plurality of reel positions of the at least one of the reels. The method further comprises detecting, via the value input device, a physical item associated with a monetary value that establishes a credit balance, receiving an input indicative of a wager covered by the credit balance, and spinning and stopping the plurality of reels to land a subset of the symbols on the reels in visual association with an array of positions. In response to the symbol clump landing at least partially in the array, the method further comprises modifying, by the game-logic circuitry, an attribute of the array in accordance with an extent to which the symbol clump lands in the array.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is a representation of a help screen to explain the symbol clump feature in accord with at least some aspects of the disclosed concepts.

FIGS. 5 to 7 are screenshots of the different wagering game outcomes in accord with at least some aspects of the disclosed concepts.

FIG. 8 is a flowchart for an algorithm that corresponds to instructions executed by a controller in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

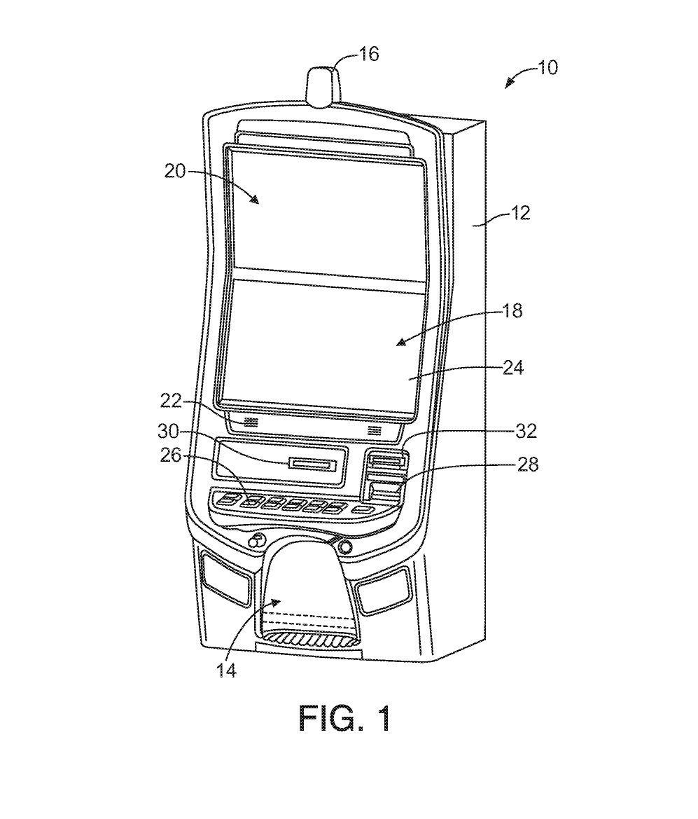

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

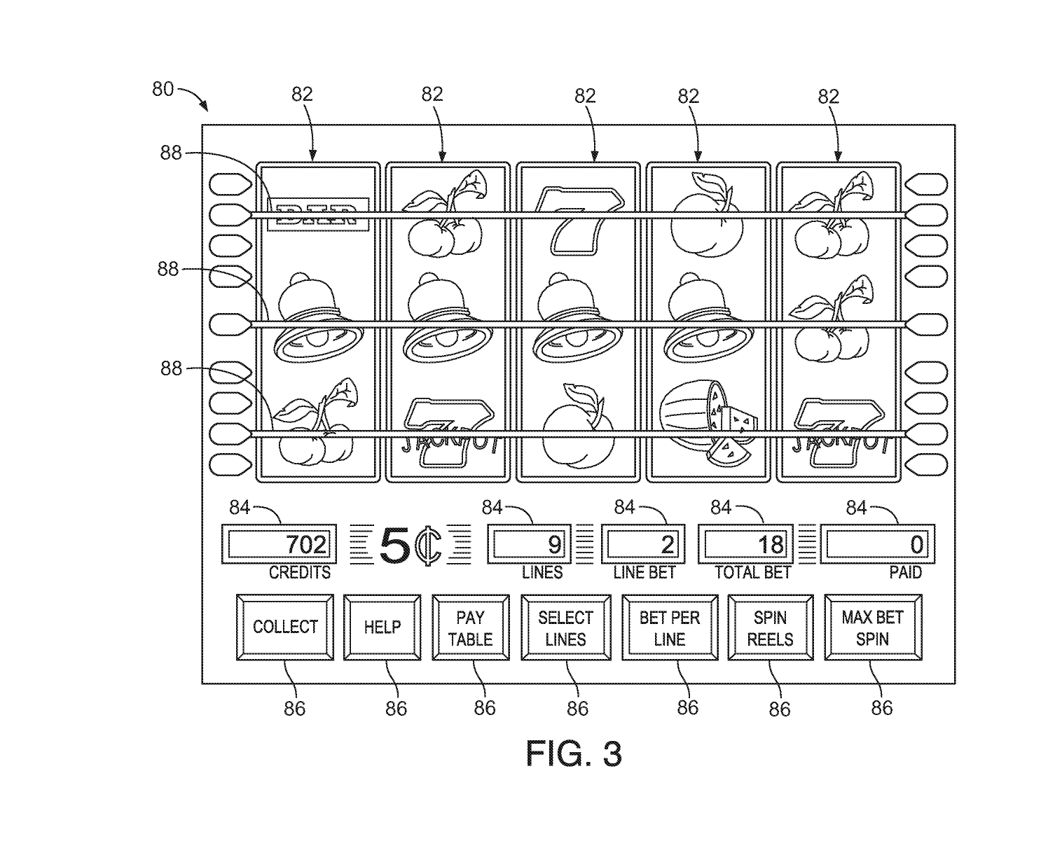

The gaming machine 10 includes one or more value input/payment devices and value output/payout devices. The value input devices are used to deposit cash or credits onto the gaming machine 10. The cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. A value input device is configured to detect a physical item, such as coins, currency, cards, etc., associated with a monetary value that establishes a credit balance on a credit meter such as the “credits” meter 84 (see FIG. 3). In response to a cashout input that initiates a payout from the credit balance on the “credits” meter 84, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

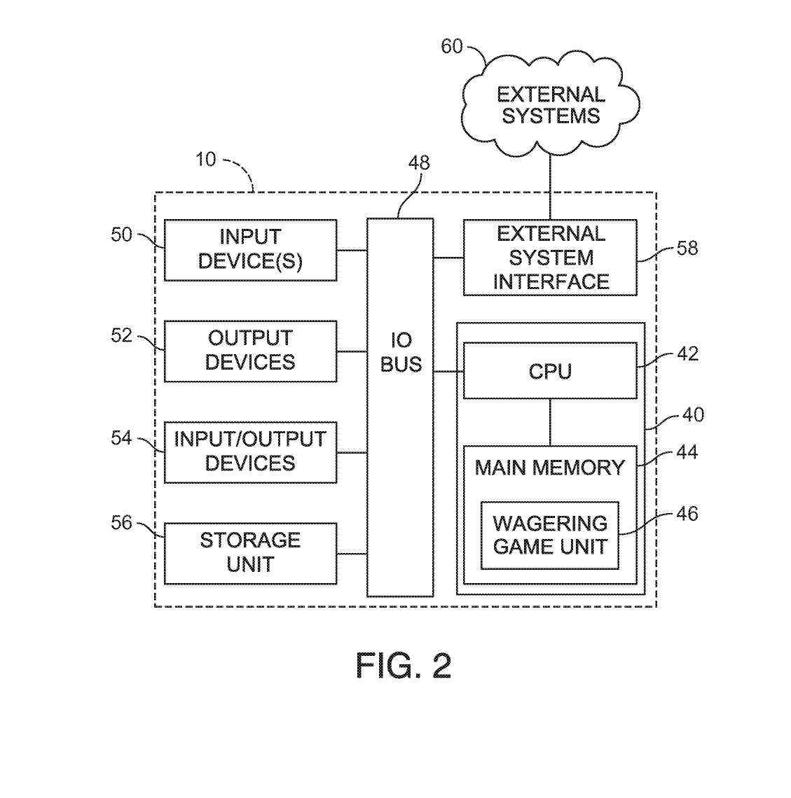

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by the credit balance on the “credits” meter 84, the reels 82 are spun and stopped to land a subset of the symbols on the reels in visual association with an array of positions on which paylines, such as paylines 88, are defined. The wagering game evaluates the displayed symbols that have landed in the array of positions and provides immediate awards and bonus features in accordance with a defined pay scheme, such as a pay table. The pay table may, for example, include “line pays” or “scatter pays”. Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

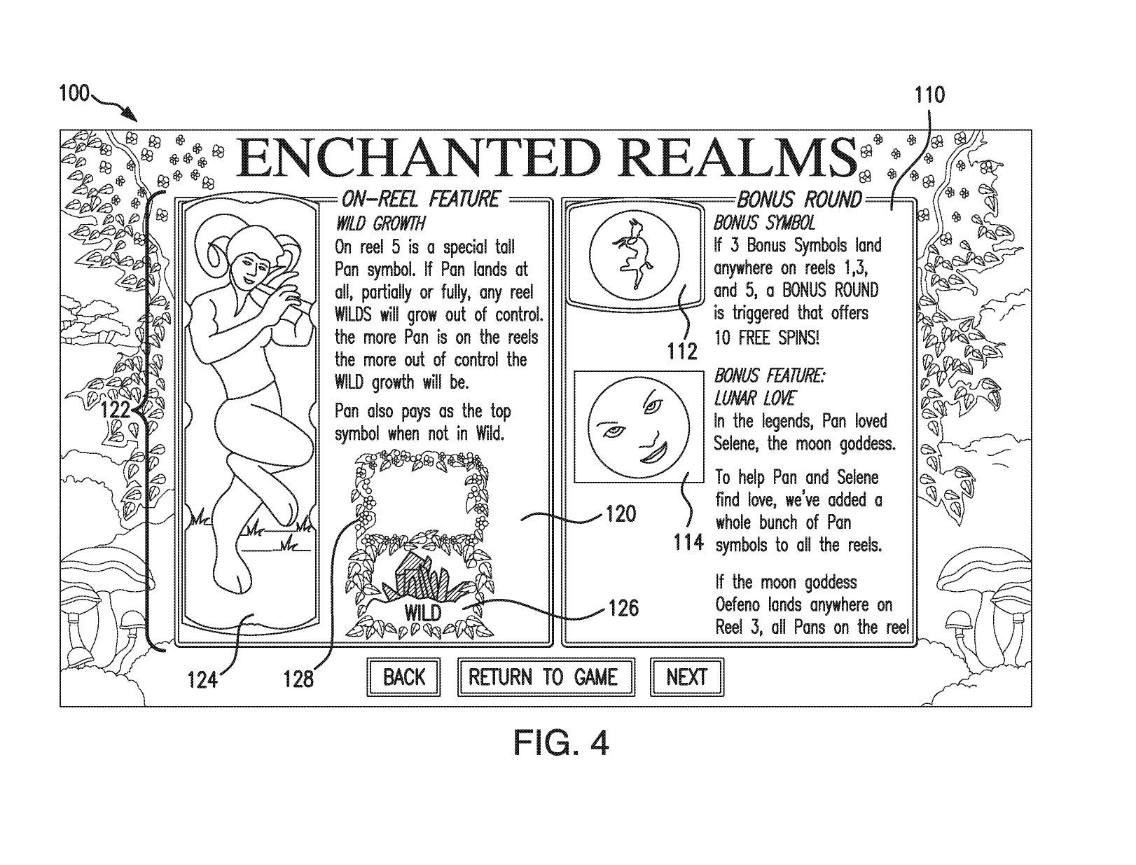

Referring to FIG. 4, a representation of a help screen 100 is provided on the primary display 18 or secondary display 20 that contains information on the features that may be activated during play of the gaming machine 10. Players may access the help screen at any time by pressing a dedicated “help” button provided on the touch screen 24 or button panel of the gaming machine 10. Information is presented in two separate panels 110, 120 of the help screen 100. Information panel 110 provides a description of a bonus feature in the form of a bonus round, while information panel 120 relates to the symbol clump feature that may be triggered during play of either the basic game or the bonus round.

The symbol clump feature is triggered if any part of a symbol clump lands during play of the basic-game or bonus round. As used herein, the term “clump” or “symbol clump” refers to one or more of the same symbols occupying two or more reel positions located immediately adjacent one another on the same reel. Accordingly, a symbol clump can be formed by the same symbol appearing over consecutive reel positions so as to provide a “run” or “stack” of identical symbols on the same reel. Alternatively, a symbol clump can be formed by a single, elongate or enlarged symbol appearing over consecutive reel positions of the same reel. In the particular embodiment shown, the symbol clump 122 is depicted as a PAN symbol 124 spanning four reel positions and appears on reel 5 of the array. In this case, each reel position of the symbol clump 122 forms a section of an overall image that makes up the PAN symbol 124, such that each reel position is treated as being occupied by the same symbol. Although not specifically referred to, other PAN symbols 124 are provided that occupy one reel position on the reels to depict only the head section of the overall image. In this case, both types of PAN symbol 124 are assigned as the top paying symbol in the game and, as such, are identified as the same symbol when determining payouts. However, only the PAN symbol 124 that appears on reel 5 of the array activates the symbol clump feature, since this is the only PAN symbol 124 that forms a clump of symbols 122 in the array. In the event that the symbol clump 122 lands either partially or fully, an attribute of the array is modified according to the extent the symbol clump 122 lands in the array, as discussed in more detail below.

As shown in information panel 110, the bonus feature is triggered by the appearance of three BONUS symbols 112 anywhere in the array during the basic game and awards ten free spins. An additional bonus feature may be provided during the bonus round if a special trigger symbol appears in the array. In the particular embodiment shown, a SELENE symbol 114 appearing anywhere on reel 3 of the array during the bonus round will transform any PAN symbols that appear in the array into WILD symbols.

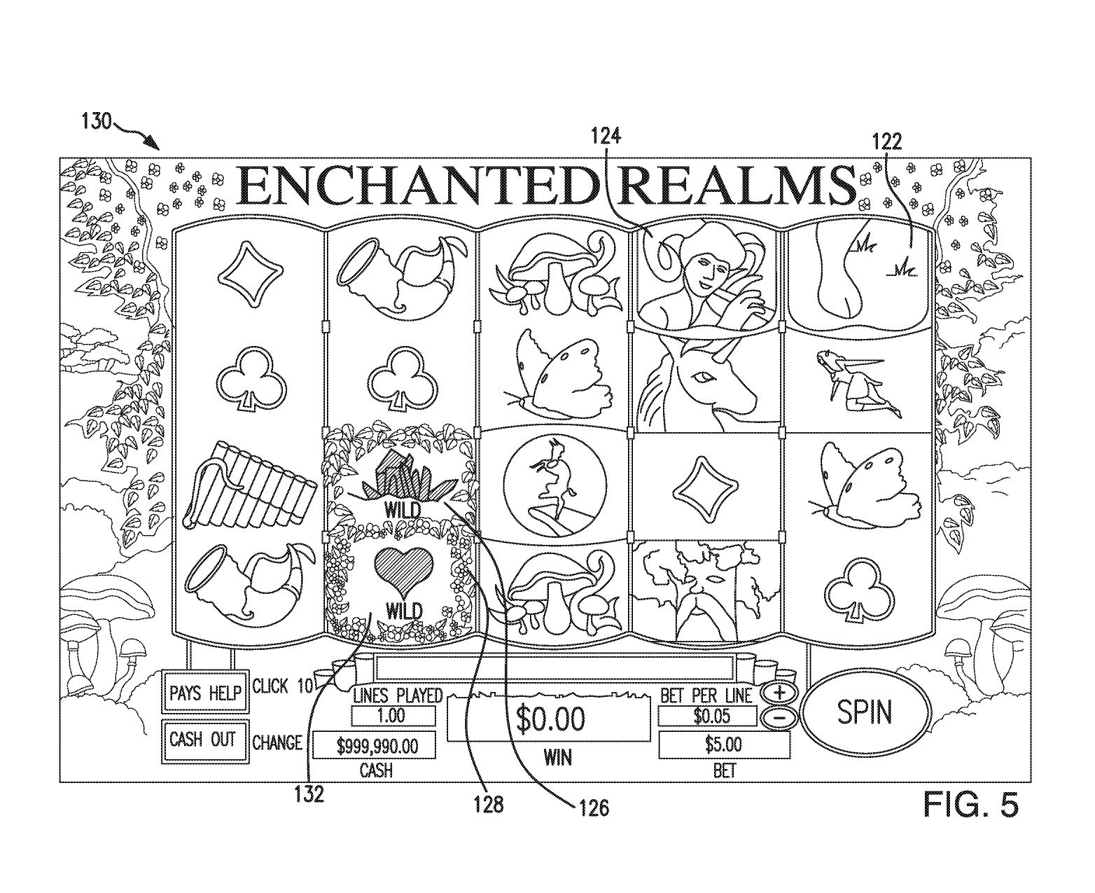

Referring now to FIGS. 5 to 7, a number of screenshots of different wagering game outcomes are provided to show the symbol clump feature in operation. In the present case, each screenshot depicts a separate outcome as a result of spinning and stopping the reels to land a subset of symbols in visual association in the array of positions. In particular, FIGS. 5 to 7 each show a different number of reel positions of the symbol clump have landed in the array 130 to affect the extent that the attribute is modified. For example, in referring back to the help screen 100 of FIG. 4, if the symbol clump 122 lands either partially or fully in the array, any WILD symbols 126 that appear in the array 130 will expand based on the number of reel positions of the symbol clump that land. While the WILD symbol 126 is selected as the attribute of the array 130 that is modified by expanding the symbol, it should be appreciated that in alternative forms, any symbol appearing in the array may be selected to be modified, and that modification is not limited to expansion, as discussed below.

As shown in FIG. 5, the random outcome that occurs in array 130 has resulted in one reel position of the symbol clump 122 landing on reel 5. In this case, the WILD symbol 126 has expanded over one neighboring reel position of the reel since only one reel position of the clump 122 has landed in the array 130. In referring back to the help screen 100 of FIG. 4, symbol expansion is indicated by utilizing a special border around any reel positions the WILD symbol 126 expands over, as depicted by a garland of flowers 128 surrounding the HEART symbol 132. The HEART symbol 132 also appears in shadow with the word WILD appearing underneath to further emphasize that this reel position now operates as a WILD symbol. While a PAN symbol 124 also appears adjacent the symbol clump 122, this symbol does not form part of the clump 122 and, as such, does not affect the extent that the WILD symbol 126 expands.

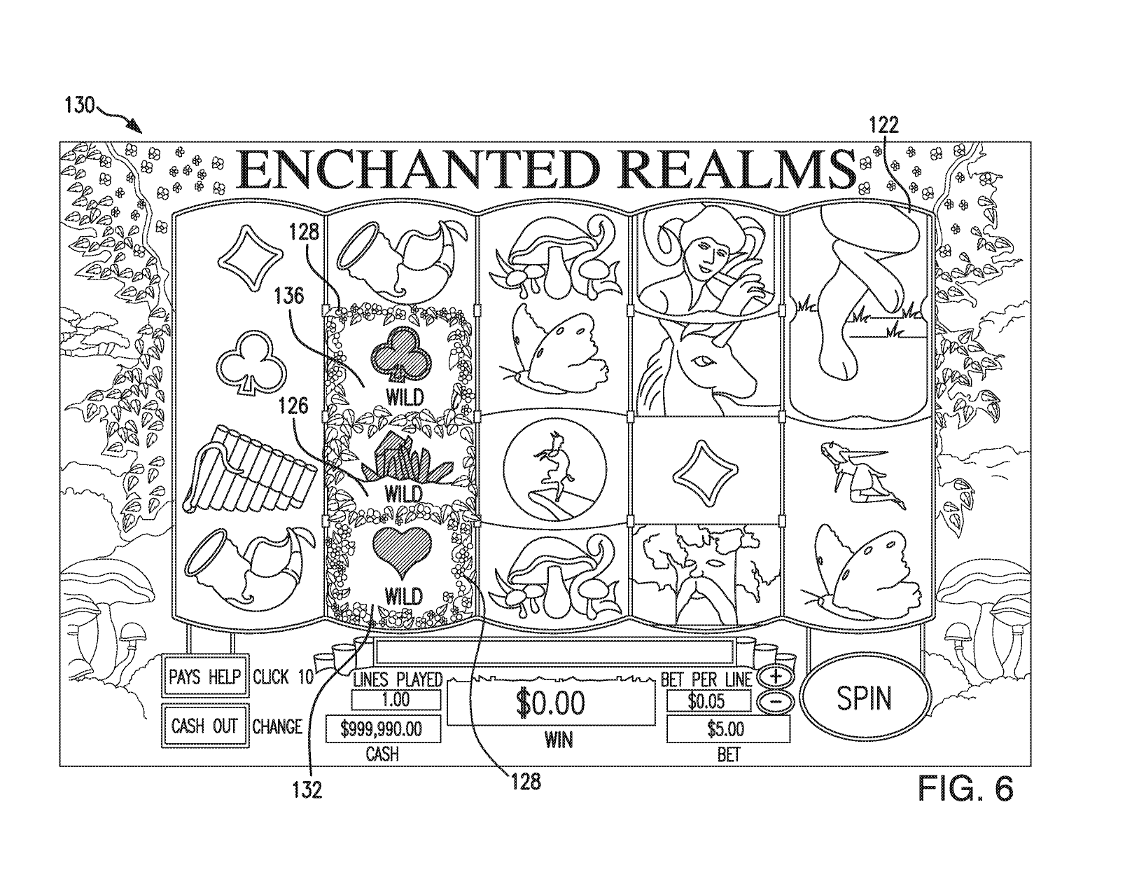

As shown in FIG. 6, the random outcome that occurs in array 130 has resulted in two reel positions of the symbol clump 122 landing on reel 5. In this case, the WILD symbol 126 expands over two reel positions, as depicted by the garland of flowers 128 surrounding both the HEART and CLUB symbols 132, 136 that now appear in shadow. In the particular embodiment shown, the WILD symbol 126 expands over the reel on which it lands, such that it only expands vertically within the array. However, it should be realized that in alternative embodiments, the WILD symbol 126 may expand vertically, horizontally and/or diagonally within the array 130, such that symbol expansion need not be limited to only one direction.

When comparing FIGS. 5 and 6, it will be seen that an accumulating effect occurs between the extent of reel positions of the symbol clump 122 that land in the array 130 and the amount an attribute of the array is modified. For example, if three reel positions of the symbol clump 122 had landed on reel 5 instead of the one or two reel positions shown in FIGS. 5 and 6, respectively, it will be apparent the WILD symbol that appears on reel 2 will similarly expand over three reel positions to cover reel 2 completely, thus providing the player a greater chance the WILD symbol will form part of a winning symbol combination due to its expanded state.

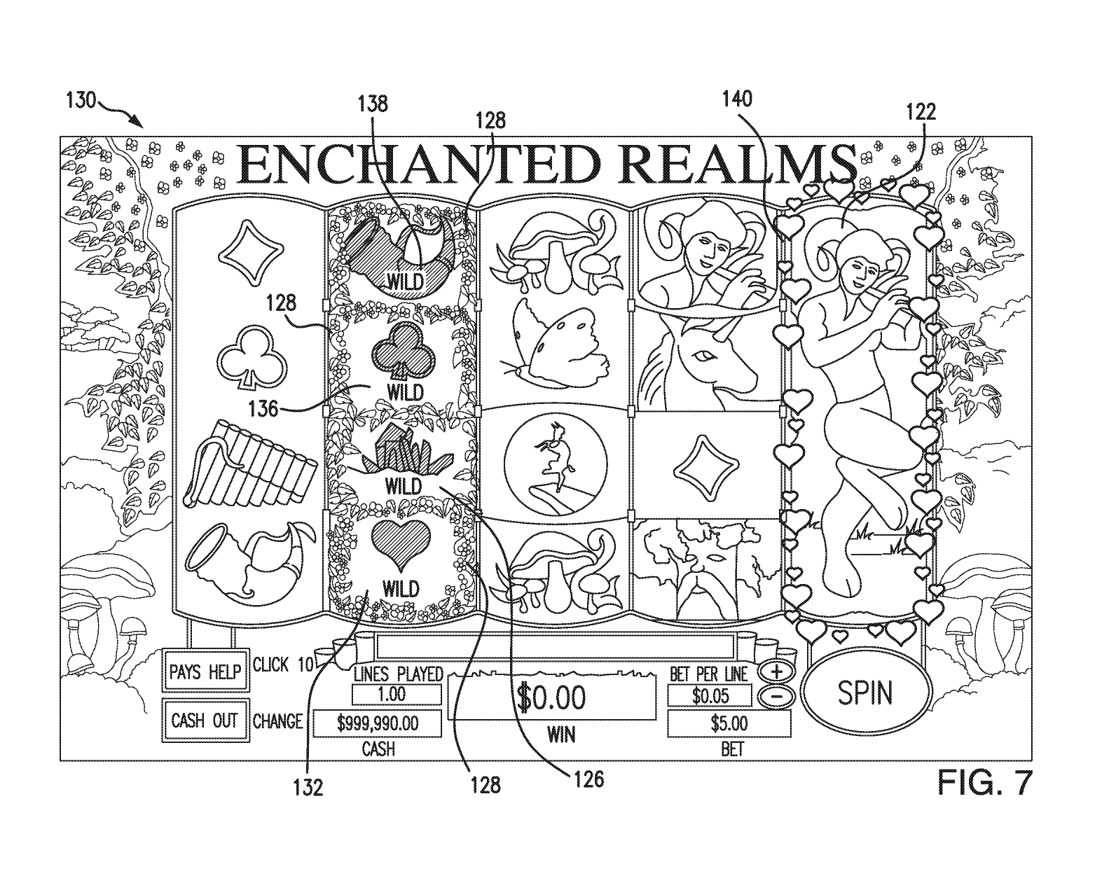

As shown in FIG. 7, the random outcome that occurs in array 130 has resulted in all four reel positions of the symbol clump 122 landing on reel 5. In this case, the WILD symbol 126 has expanded over three reel positions, as depicted by the garland of flowers 128 surrounding the HEART, CLUB and HORN symbols 132, 136, 138 that now appear in shadow. As previously referred to earlier, the WILD symbol 126 can only expand vertically over the reel on which it lands, such that it will reach the full extent it can be modified when three reel positions of the symbol clump 122 appear on reel 5. As such, an additional attribute of the array is modified when all four reel positions of the symbol clump 122 land on reel 5 to preserve the accumulative effect that occurs between the extent of reel positions of the symbol clump 122 that land in the array 130 and the amount an attribute/s of the array is modified. For example, in referring back to the help screen of FIG. 4, when all four reel positions of the symbol clump 122 land in the array, the symbol clump 122 is also modified by operating as a WILD symbol. In FIG. 7, this is indicated by a special border of heart-shaped sprites 140 that now surrounds the symbol clump 122. Of course, as an alternative to the embodiments shown in FIGS. 4 to 7, the WILD symbol may expand either horizontally or diagonally across the reels such that the WILD symbol can continue expanding as the number of reel positions of the symbol clump 122 landing in the array increases.

As an alternative to the above embodiment, symbols may be upgraded or replaced when a symbol clump lands either partially or fully in the array. For example, since a set of symbols used in the game typically follow a hierarchical order in which lower ordered symbols are associated with lower prize values than higher ordered symbols according to a pay scheme (i.e., paytable), a lower ordered symbol may be replaced with a higher ordered symbol to improve the chance of a winning symbol combination appearing in the array that is associated with a higher prize value. For example, the lowest ordered symbol in a set of symbols used to populate the reels of the array may be replaced by the highest ordered symbol when one reel position of the symbol clump lands in the array. Similarly, the lowest and second lowest ordered symbol may be replaced by the highest ordered symbol in the set when two reel positions of the symbol clump land in the array. Such replacement may continue until all other symbols in the set are replaced by the highest ordered symbol. However, it should be realized that symbol replacement need not be restricted to replacing the lowest ordered symbols with the highest ordered symbol in the set. As an example, if a symbol set contains eight different symbol types and a total of four reel positions of the symbol clump can land in the array at any one time, the lowest ordered four symbols may be replaced with the highest ordered four symbols in sequential order according to the number of reel positions of the symbol clump that land in the array. It is to be realized other arrangements of symbol replacement are possible, such that the above examples should not be considered limitative.

As a further alternative, a win multiplier may be selected as the attribute of the array that is modified. In this case, the win multiplier may be applied to a specific symbol, such as any WILD symbols that land in the array, that is incremented according to the number of reel positions of the symbol clump that land in the array. For example, when one reel position of the symbol clump appears in the array, a ×2 win multiplier will be added to any WILD symbols that appear in the array and applied to the payout for any winning symbol combination formed at least in part by the WILD symbol. Similarly, when two reel positions of the special tall PAN symbol appears in the outcome, a ×3 win multiplier is added to any WILD symbols that appear in the array. Alternatively, the win multiplier may be increased non-linearly and may be applied to the payout of each and every winning symbol combination that appears in the outcome, regardless of whether a WILD symbol forms part of each winning symbol combination.

In yet another alternative, the size of the array or the number of paylines or reel position combinations which the subset of symbols are evaluated for winning outcomes may be selected as the attribute that is modified according to the number of reel positions of the symbol clump that land in the array. For example, an additional reel may be added to the array to increase the number of symbols that may be involved in a winning symbol combination, in which case the pay scheme may also be increased or adjusted accordingly. Similarly, an additional row may be added to the array to increase the number of possible winning symbol combinations provided by the array. Alternatively, as previously implied, a number of new paylines or reel position combinations may be added to the array according to the number of reel positions of the symbol clump that land in the array without changing the size of the array.

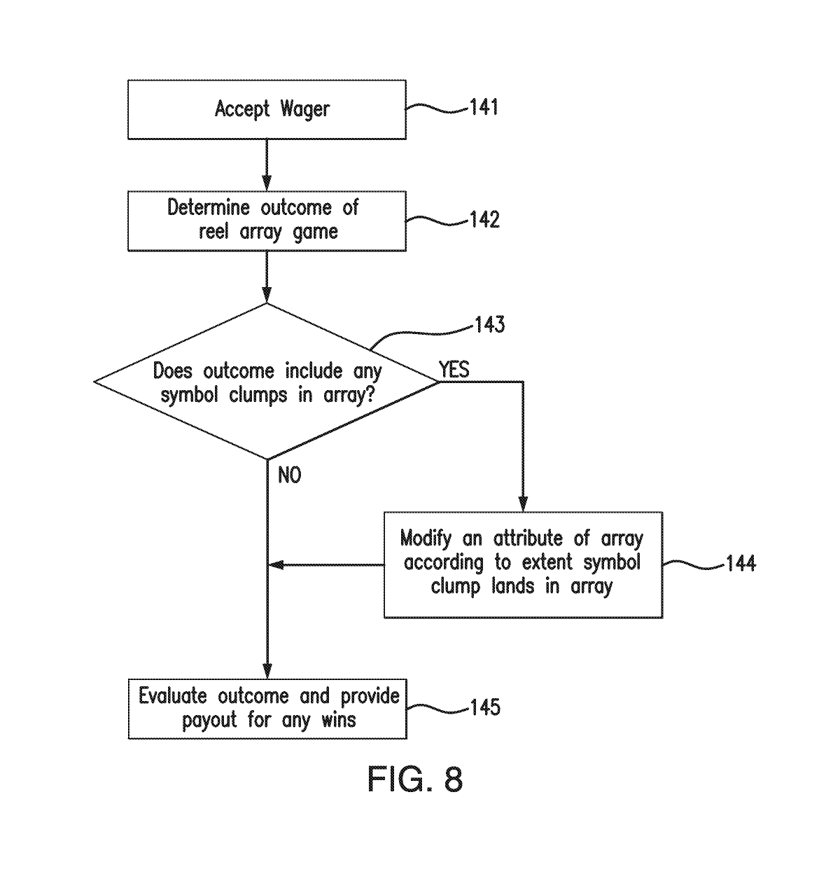

FIG. 8 shows one example of various operations performed by rule sets in accord with one aspect of the present concepts in which a computer readable media bearing instructions is accessed by one or more processors, which execute the instructions and causes the performance of operations in association with the symbol clump feature described in any of the various aspects described herein. FIG. 8 shows an example wherein such operations include accepting a wager to play the wagering game step 141). The instructions further cause the processors to determine a randomly selected outcome depicted by a plurality of symbols populating an array of reel positions (step 142). The instructions further require processors to determine if any clump of symbols land in the array of reel positions of the outcome (step 143). In the event that a symbol clump land in the array, the instructions further require processors to modify an attribute of the array according to the extent the symbol clump appears in the array (step 144). The instructions further provide for the processors to evaluate the outcome and provide a payout for any winning symbol combinations occurring in the outcome according to a payable (step 145).

FIG. 8, described by way of example above, represents one algorithm that corresponds to at least some instructions stored and executed by the game-logic circuitry 40 in FIG. 2 to perform the above described functions associated with the disclosed concepts.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A gaming system, comprising:
a regulated gaming machine primarily dedicated to playing at least one casino wagering game, the gaming machine including an electronic display device and a value input device; and
game-logic circuitry configured to:
display, on the electronic display device, a plurality of symbol-bearing reels, each reel having a plurality of reel positions occupied by symbols, the symbols on at least one of the reels including a symbol clump occupying two or more adjacent reel positions of the plurality of reel positions of the at least one of the reels;
detect, via the value input device, a physical item associated with a monetary value that establishes a credit balance;
receive an input indicative of a wager covered by the credit balance;
spin and stop the plurality of reels to land a subset of the symbols on the reels in visual association with an array of positions; and
in response to the symbol clump landing at least partially in the array, modify an attribute of the array in accordance with an extent to which the symbol clump lands in the array.

2. The gaming system of claim 1, further including a random element generator configured to generate one or more random elements, the outcome being randomly selected based, at least in part, on the one or more random elements.

3. The gaming system of claim 1, wherein the random element generator and the game-logic circuitry reside within a gaming cabinet of the gaming machine.

4. The gaming system of claim 1, wherein the physical item is selected from a group consisting of a currency bill, a coin, a ticket, a voucher, a coupon, a card, and a computer-readable storage medium.

5. The gaming system of claim 1, wherein the attribute is selected from a group consisting of: an expandable symbol, an upgradable symbol, a win multiplier, a size of the array, and a number of paylines or reel position combinations which the subset of symbols are evaluated for winning outcomes.

6. The gaming system of claim 5, wherein the expandable symbol is a wild symbol that expands one reel position for each reel position of the symbol clump that lands in the array.

7. The gaming system of claim 5, wherein the upgradable symbol is included in the symbol clump and is upgraded to a wild symbol when the symbol clump lands fully in the array.

8. A casino gaming machine primarily dedicated to playing at least one casino wagering game, comprising:
an electronic display device;
a value input device; and
game-logic circuitry configured to:
display, on the electronic display device, a plurality of symbol-bearing reels, each reel having a plurality of reel positions occupied by symbols, the symbols on at least one of the reels including a symbol clump occupying two or more adjacent reel positions of the plurality of reel positions of the at least one of the reels;
detect, via the value input device, a physical item associated with a monetary value that establishes a credit balance;
receive an input indicative of a wager covered by the credit balance;
spin and stop the plurality of reels to land a subset of the symbols on the reels in visual association with an array of positions; and
in response to the symbol clump landing at least partially in the array, modify an attribute of the array in accordance with an extent to which the symbol clump lands in the array.

9. The casino gaming machine of claim 8, further including a random element generator configured to generate one or more random elements, the outcome being randomly selected based, at least in part, on the one or more random elements.

10. The casino gaming machine of claim 8, wherein the random element generator and the game-logic circuitry reside within the gaming cabinet.

11. The casino gaming machine of claim 8, wherein the physical item is selected from a group consisting of a currency bill, a coin, a ticket, a voucher, a coupon, a card, and a computer-readable storage medium.

12. The casino gaming machine of claim 8, wherein the attribute is selected from a group consisting of: an expandable symbol, an upgradable symbol, a win multiplier, a size of the array, and a number of paylines or reel position combinations which the subset of symbols are evaluated for winning outcomes.

13. The gaming system of claim 12, wherein the expandable symbol is a wild symbol that expands one reel position for each reel position of the symbol clump that lands in the array.

14. The gaming system of claim 12, wherein the upgradable symbol is included in the symbol clump and is upgraded to a wild symbol when the symbol clump lands fully in the array.

15. A method of operating a gaming system primarily dedicated to playing at least one regulated casino wagering game, the gaming system including game-logic circuitry and a gaming machine, the gaming machine including an electronic display device and a value input device, the method comprising:
displaying, on the electronic display device, a plurality of symbol-bearing reels, each reel having a plurality of reel positions occupied by symbols, the symbols on at least one of the reels including a symbol clump occupying two or more adjacent reel positions of the plurality of reel positions of the at least one of the reels;
detecting, via the value input device, a physical item associated with a monetary value that establishes a credit balance;
receiving an input indicative of a wager covered by the credit balance;
spinning and stopping the plurality of reels to land a subset of the symbols on the reels in visual association with an array of positions; and
in response to the symbol clump landing at least partially in the array, modifying, by the game-logic circuitry, an attribute of the array in accordance with an extent to which the symbol clump lands in the array.

16. The method of claim 15, wherein the attribute is selected from a group consisting of: an expandable symbol, an upgradable symbol, a win multiplier, a size of the array, and a number of paylines or reel position combinations which the subset of symbols are evaluated for winning outcomes.

17. The gaming system of claim 16, wherein the expandable symbol is a wild symbol that expands one reel position for each reel position of the symbol clump that lands in the array.

18. The gaming system of claim 16, wherein the upgradable symbol is included in the symbol clump and is upgraded to a wild symbol when the symbol clump lands fully in the array.
